(19) United States
(12) Patent Application Publication
(10) Pub. No.: US 2011/0265641 A1
(43) Pub. Date: Nov. 3, 2011

(54) FORCE AMPLIFIER

(75) Inventors: John Michael Morris, Auburn, WA (US); Todd E. Moyer, Dalton, OH (US); David T. Swank, Millersburg, OH (US)

(73) Assignees: Orscheln Products L.L.C, Moberly, MO (US); Norgren GT Development Corporation, Auburn, WA (US)

(21) Appl. No.: 13/183,768

(22) Filed: Jul. 15, 2011

Related U.S. Application Data
(63) Continuation-in-part of application No. 11/848,589, filed on Aug. 31, 2007.

(51) Int. Cl. F15B 9/10; B23P 15/00

(52) U.S. Cl. 91/376 R; 29/890.09

(57) ABSTRACT

A force amplifier comprising a housing is provided. The force amplifier includes a force assembly positioned in the housing. The force assembly comprises an input force component, an output force component, and an intermediate force component rigidly coupling the input force component to the output force component. An assist piston is positioned in the housing. The assist piston is coupled to the force assembly. A regulating piston is positioned in the housing. The regulating piston is coupled to the force assembly. The regulating piston controls the supply of a pressurized fluid acting on the assist piston.

### RELATED APPLICATIONS

This application is a continuation in part application of U.S. application Ser. No. 11/848,589 filed Aug. 31, 2007 entitled “Force Amplifier” which is hereby incorporated by reference into this application.

### TECHNICAL FIELD

The present invention relates to a force amplifier, and more particularly, to a force amplifier utilizing a pressurized fluid.

### BACKGROUND OF THE INVENTION

Force amplifiers are commonly known and are typically employed in applications where human input force is inadequate. Alternatively, they are employed where human input may be adequate, but can become uncomfortable and/or unreliable under extended periods of time. One such application is with regard to the operation of a clutch in large commercial vehicles. In some circumstances a driver may be able to overcome the high clutch force, but repeated use can become uncomfortable to the driver and may result in premature fatigue. However, through the use of a force amplification system, the amount of force required of the driver can be substantially reduced, while the output force remains the same.

Typically, force amplifiers add additional force to an output using some pressurized fluid. The force amplifier converts the pressure supplied by the fluid into mechanical energy. The fluid can operate to multiply the force provided at the input to create a greater force at the output of the force amplifier.

Some of the prior art systems that attempt to provide adequate force amplification systems have numerous drawbacks. One such example is disclosed in U.S. Pat. No. 5,279,204 to Eugene. The power booster of Eugene suffers from a number of drawbacks. The complexity of the Eugene system results in increasing the force needed by a user in the event of a pressure failure. This is because the user must overcome a number of biasing members when applying a force on the input shaft before any movement of the output shaft is realized. This can amount in having a more negative effect in the absence of pressure than if the power booster were eliminated altogether. Furthermore, the input shaft is required to move a greater distance than reflected in the output shaft, i.e., the input distance is not in a 1:1 ratio with the output distance.

Another prior art system is disclosed in U.S. patent application 2004/0016618 to Burnell et al. The Burnell system requires a number of switches which transmits a clutch pedal position into an amount of boost required. Therefore, one module senses the tension by a user and a separate module provides the force amplification. This type of a system requires more space to function and results in an overly complex system.

The present invention overcomes these and other problems and an advance in the art is achieved.

### SUMMARY OF THE INVENTION

A force amplifier is provided according to an embodiment of the invention. The force amplifier comprises a housing and a force assembly positioned in the housing. The force assembly includes an input force component, an output force component, and an intermediate force component. The intermediate force component rigidly couples the input force component to the output force component. The force amplifier further comprises an assist piston positioned in the housing. The assist piston is coupled to the force assembly. The force amplifier further comprises a regulating piston positioned in the housing and coaxially aligned with the assist piston. The regulating piston is coupled to the force assembly. The regulating piston by working in conjunction with the operator's input force controls the supply of a pressurized fluid acting on the assist piston.

A method for forming a force amplifier including a housing is provided according to an embodiment of the invention. The method comprises the steps of positioning a force assembly in the housing. The force assembly includes an input force component, an output force component, and an intermediate force component. The intermediate force component rigidly couples the input force component to the output force component. The method further comprises the step of positioning an assist piston in the housing. The method further comprises the step of coupling the assist piston to the force assembly. The method further comprises the steps of positioning a regulating piston in the housing coaxially aligned with the assist piston. The method further comprises the step of coupling the regulating piston to the force assembly. The regulating piston controls the supply of a pressurized fluid acting on the assist piston and works in conjunction with the level of operator input.

A method for amplifying a force using a force amplifier is provided according to an embodiment of the invention. The method comprises the step of receiving a first force on a force assembly. The method further comprises the step of actuating a regulating piston with the first force. The regulating piston provides a pressurized fluid to an assist piston, which is coaxially aligned with the regulating piston, when the regulating piston is actuated. The method adds a second force from the pressurized fluid by acting on the assist piston. A total output force of the force assembly comprises the first force plus the second force.

### BRIEF DESCRIPTION OF THE DRAWINGS

FIG. 1 shows a force amplifier according to an embodiment of the invention.

FIG. 2 shows a cross sectional view of the force amplifier taken along line 2-2 of FIG. 1.

FIG. 3A shows the force amplifier according to an embodiment of the invention.

FIG. 3B shows the poppet chamber according to another embodiment of the invention.

FIG. 4A shows the force amplifier when a force is applied to the input.

FIG. 4B shows the poppet chamber when a force is applied to the input.

FIG. 5A shows the force amplifier under a substantially constant force.

FIG. 5B shows the poppet chamber under a substantially constant force.

FIG. 6A shows the force amplifier with the force on the input decreasing.

FIG. 6B shows the poppet chamber with the force on the input decreasing.

FIG. 7 shows a cross sectional view of the force amplifier taken along line 2-2 of FIG. 1.

### DETAILED DESCRIPTION OF THE INVENTION

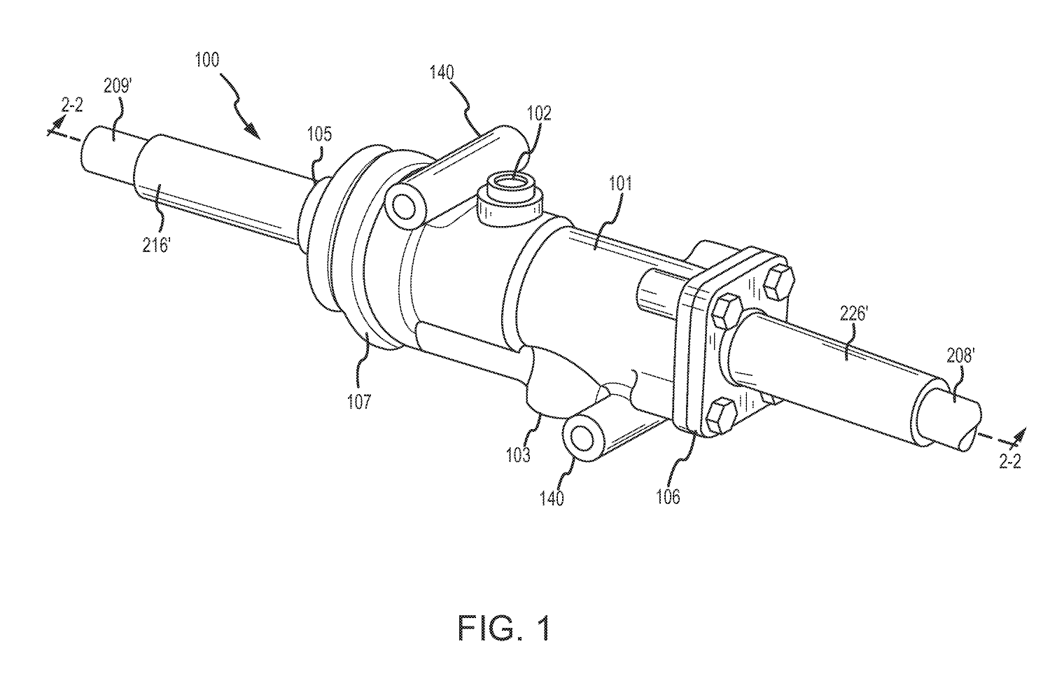

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a force amplifier 100 according to an embodiment of the invention. The force amplifier 100 includes a housing 101, a fluid input 102, a fluid exhaust 103, an aperture 104 formed in a first side of the housing, an aperture 105 formed in a second side of the housing, a housing cap 106, and a protective boot 107. The force amplifier 100 optionally includes one or more mounts 140. The mounts 140 can be provided to assist in installing the force amplifier 100.

The housing 101 can be provided with a housing cap 106 at the input end. The housing cap 106 in some embodiments includes the aperture 104. The housing cap 106 can also close the input end of the force amplifier 100. The housing cap 106 can be attached to the housing screws, adhesives, welding, brazing, or any other form of bonding known in the art.

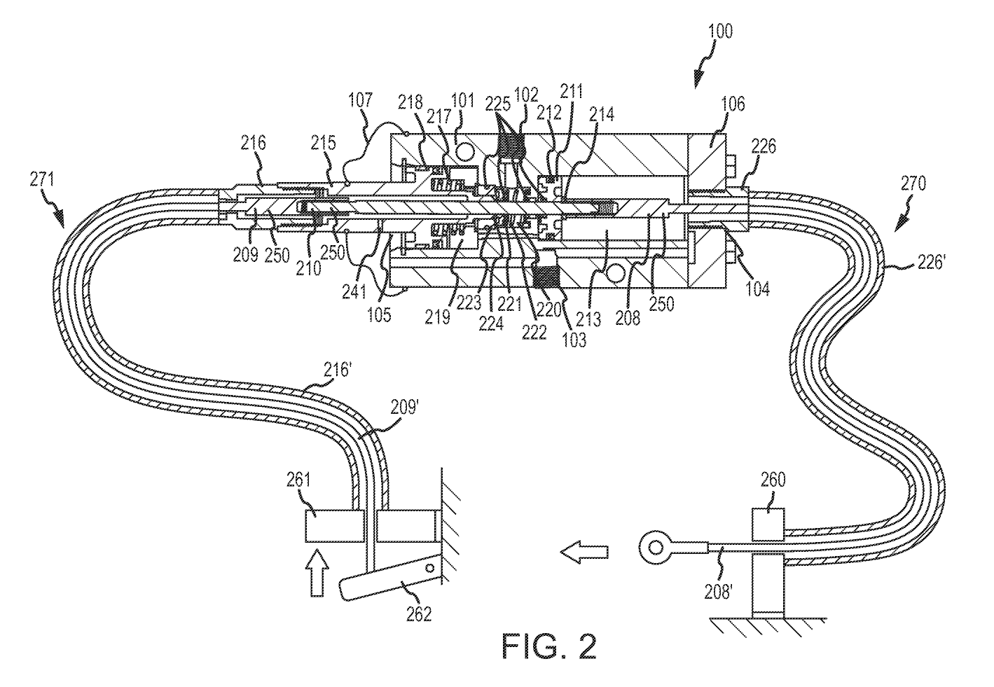

The housing 101 can be provided with a protective boot 107. In some embodiments, the protective boot 107 comprises a rubber protective seal. However, the protective boot 107 can comprise other materials that would allow sufficient flexibility in order to allow the regulating piston 215 (described below) to move as a result of a reaction force from a sheath member 271 of a Bowden Cable System (See FIG. 2). The protective boot 107 can be provided to decrease the amount of dirt and debris that enters the housing 101. Additionally, the protective boot 107 can be provided to form a passageway for the fluid exhaust (described below).

The force amplifier 100 can communicate with a pressurized fluid supply (not shown). The fluid input 102 can accept the pressurized fluid from the supply and employ the pressurized fluid to amplify a force provided at the aperture 104 as described in more detail below. The pressurized fluid can comprise a pneumatic supply, hydraulic fluid, or other known fluids used in fluid-mechanic operations. It should be understood that the fluid can comprise either a gas or a liquid.

The pressurized fluid can be exhausted from the force amplifier 100 through the fluid exhaust 103. Although FIG. 1 shows the fluid input 102 at the top and the fluid exhaust 103 at the bottom of the force amplifier 100, it should be understood that the location of these components can be changed and adjusted to meet the needs of individual applications.

The input aperture 104 is provided to accept an input force component (described below). Likewise, the output aperture 105 is provided to accept an output force component. Typically, an inner member of the output force component 271 is provided to perform some work on a work piece (not shown), while a user can directly or indirectly apply a force on the input force component. The force amplifier 100 can be provided in some embodiments to provide a force at the output that is greater than the force provided on the input force component.

FIG. 2 shows a cross sectional view of the force amplifier 100 taken along the line 2-2 of FIG. 1. The force amplifier 100 includes a force assembly 250. The force assembly 250 is provided to receive a first force on a first end and provide an output force on a second end. The force assembly 250 comprises an input force component 208; an output force component 209; and an intermediate force component 210. The force assembly 250 is positioned in the housing 101. In the embodiment shown in FIG. 2, the input force component 208 is positioned in the aperture 104 formed in a first side of the housing 101 and the output force component 209 is positioned in an aperture 105 formed in a second side of the housing 101. However, it should be understood that in other embodiments, the input force component 208 and the output force component 209 can be positioned in a single side of the housing, i.e., positioned in the same side of the housing. In embodiments including the housing cap 106, the aperture 104 can be formed in the housing cap 106.

The input 208 and output 209 components are coupled using an intermediate force component 210. According to an embodiment of the invention, the intermediate force component 210 provides a rigid connection between the input 208 and output 209 force components, i.e., the distance between the input 208 and the output 209 force component remains substantially constant. Additionally, the intermediate force component 210 provides a 1:1 ratio between the input 208 and output 209 force components with regard to force (in the absence of pressurized fluid).

The input 208 and output 209 force components are shown as cables in FIG. 2. Specifically, the input 208 and output 209 force components are shown as comprising a portion of the cable wires 208′, 209′ of Bowden cable systems 270, 271, as are generally known in the art. When the force amplifier 100 is incorporated into a clutch actuation system of a vehicle, the input 208 and output 209 force components may be incorporated into the Bowden cable system of the vehicle for example. For example, the input force component 208 can comprise a portion of or be coupled to the Bowden cable wire 208′ of the Bowden cable system 270 that passes through a vehicle firewall 260 and is coupled to a clutch pedal (not shown). Similarly, the output force component 209 can comprise a portion of or be coupled to the Bowden cable wire 209′ of the Bowden cable system 271 that extends through a transmission housing 261 and is coupled to a clutch 262, for example. However, it should be understood that the input 208 and output 209 force components are not limited to cables and may comprise conduits, rods, hoses, etc. The force components can transfer a force under either tension or compression. The input force component 208 can include an input force component conduit 226, which substantially encloses the input force component 208. In embodiments where the input force component 208 comprises a portion of the Bowden cable wire 208′, the input force component conduit 226 can comprise a portion of or be coupled to the corresponding Bowden cable sheath 226′. Similarly, the output force component 209 can include a reaction force component conduit 216, which likewise may comprise a portion of or be coupled to the corresponding Bowden cable sheath 216′. It should be appreciated that the Bowden cable sheaths 216′, 226′ may comprise a composite structure consisting of a helical steel wire, which may be lined with plastic and include a plastic outer sheath or the Bowden cable sheaths 216′, 226′ may simply comprise coiled wire without a protective covering. In another embodiment, the Bowden cable sheaths 216′, 226′ may comprise a stranded conduit of a fixed length. The reaction force component conduit 216 is discussed further below. As discussed above, in one embodiment of the invention, the input force component 208 can be coupled to a user actuated device, for example a clutch pedal. According to another embodiment of the invention, the output force component 209 can be coupled to a work piece, such as a clutch.

In the embodiment shown, an assist piston 211 is coupled to the force assembly 250. According to one embodiment of the invention, the assist piston 211 is coupled to the input force component 208 and the intermediate force component 210. However, the assist piston 211 can be coupled to any of the components of the force assembly 250. The assist piston 211 includes piston seals 212 which form a substantially fluid tight seal with an assist piston chamber 213. The assist piston 211 can move along with the force assembly when a force is applied to the input force component 208. The assist piston 211 is shown coupled to the end of the input force component 208 and to the intermediate force component 210 using a nut 214. It should be understood however, that the assist piston 211 can be coupled to the force assembly in a number of different ways including, but not limited to, adhesives, welding, brazing, or some other manner of bonding. The assist piston 211 is provided to amplify the force that is provided on the input force component 208. The function of the assist piston 211 is discussed further below.

In the embodiment shown, a regulating piston 215 is coupled to the sheath 271 of the Bowden cable system 271 via a reaction force component conduit 216. According to the embodiment shown in FIG. 2, the regulating piston 215 is coupled to the reaction force component conduit 216. According to the embodiment shown in FIG. 2, the regulating piston 215 guides the output force component 209 through the reaction force component conduit 216. While the reaction force component conduit 216 is shown as threadedly engaging the regulating piston 215, it should be understood that they could be connected in other ways including adhesives, brazing, welding, or some other manner of bonding known in the art. According to other embodiments, the reaction force component conduit 216 is free to move within the limits of the regulating piston 215. The output force component 209 can be movable within the reaction force component conduit 216. This is generally known for Bowden cable systems. The reaction force component conduit 216 is provided to transfer the energy provided on the input of the force assembly 250 into a compression force. Because the regulating piston 215 is coupled to the force assembly 250, the compression force is then delivered to the regulating piston 215. As is generally known in the art, when a Bowden cable wire is in tension with a given force, the Bowden cable sheath experiences a substantially equal amount of force in compression as the Bowden cable sheath attempts to maintain a predetermined spacing. For example, in the presently described embodiment, if the force assembly 250 is coupled to the reaction force component conduit 216 using the Bowden cable system 271 and the force assembly 250 is in tension due to a user actuating a clutch pedal, the output force component 209 along with the inner Bowden cable wire 209′ would attempt to straighten and become as short as possible. However, the reaction force component conduit 216 and Bowden cable sheath 216′ counter this tension and are put into compression with a substantially equal amount of force. In the embodiment shown, movement of the housing 101 towards the firewall 260 is minimal due to the input force component conduit 226 while movement of the housing 101 towards the transmission housing 261 is minimal due to the reaction force component conduit 216. Consequently, the input and reaction force component conduits 226, 216 can maintain the position of the housing 101 relatively constant due their substantially fixed lengths. Therefore, using the well-known principles of Bowden cables, the Bowden cable system 217 converts the tension provided on the Bowden cable wire 209′ and output force component 209 into a compressive force on the Bowden cable sheath 216′ and reaction force component conduit 216. This compressive force is applied to the regulating piston 215 as described in more detail below.

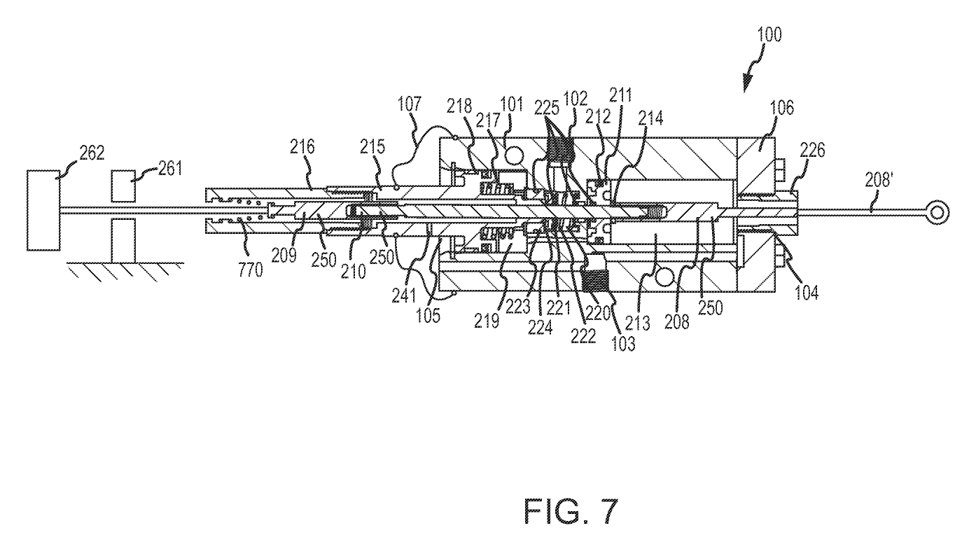

It should be appreciated however, that while the present embodiment is described using a Bowden cable system to couple the output force component 209 to the regulating piston 215 and to transfer the tension in the force assembly 250 to a compressive force applied to the regulating piston 215, other mechanical systems may be used. For example, in another embodiment, a spring assembly 770 (See FIG. 7) may be coupled to the output force component 209 at a first end and coupled to the reaction force component conduit 216 at a second end. The spring assembly 770 can allow the output force component 209 to be movable within the reaction force component conduit 216. As can be appreciated, as the output force component 209 is in tension and thus, pulled to the right, the spring assembly 770 is also pulled to the right. This stretching of the spring assembly 770 applies a compressive force on the reaction force component conduit 216. The compressive force is based upon the spring constant of the spring assembly 770 along with the length of movement. Therefore, the spring assembly 770 can be configured based upon the desired application of the force amplifier 100. The spring assembly 770 can therefore couple the force assembly 250 to the regulating piston 215. The output force component 209 is shown extending through the spring assembly 770 and coupled to a clutch 262, for example in a similar manner as in FIG. 2. The embodiment shown in FIG. 7 has also eliminated the Bowden cable system 270 at the inlet. Rather, the input force component 208 is coupled to the cable wire 208′, which may be further coupled to a clutch pedal or the like.

Returning to FIG. 2, the regulating piston 215 can be provided with a regulating piston biasing member 217. In some embodiments, the regulating piston biasing member 217 can comprise a spring. However, it should be understood that other biasing members can be used. The regulating piston biasing member 217 is provided to at least partially counter the forces that the reaction force component conduit 216 delivers to the regulating piston 215.

The regulating piston 215 is also provided with one or more sealing members 218. The sealing member 218 provides a substantially fluid tight seal between the regulating piston 215 and the regulating piston chamber 219.

The regulating piston 215 can also be provided with the protective boot 107. The protective boot 107 can prevent or at least decrease the amount of dirt and debris that can pass into the aperture 105. As shown in FIG. 2, the protective boot 107 also provides an enclosed pathway for fluid to exit an exhaust hole 241 in the regulating piston 215 and flow out through the fluid exhaust 103. However, in alternative embodiments, the fluid exhaust 103 can be provided without the exhaust hole 241. In some embodiments, the assist piston chamber 213 and the regulating piston chamber 219 each include a fluid exhaust 103.

The force amplifier 100 can include a poppet chamber 220. In the embodiment shown in FIG. 2, the poppet chamber 220 includes a regulating poppet 221 and a regulating poppet biasing member 222. The regulating poppet biasing member 222 provides a force on the regulating poppet 221, which biases the regulating poppet member 221 to the left as shown in FIG. 2. The regulating poppet member 221 can control the flow of fluid to the regulating piston chamber 219 and the assist piston chamber 213. The flow of fluid is controlled depending on the position of the poppet member 221 relative to the regulating piston 215. The force amplifier 100 includes a regulating supply seat 223 and a regulating exhaust seat 224. A plurality of sealing members 225 provide a substantially fluid tight seal between components of the force amplifier 100. The operation of the force amplifier 100 is described below with the figures that follow.

As mentioned above, while the regulating piston 215 is shown to guide the output force component 209, using either the Bowden cable system 271 or the spring assembly 770, and the assist piston 211 is shown as being coupled to the input force component 208, it should be understood that the assist piston 211 could be coupled to any of the components of the force assembly 250. Furthermore, the terms ‘input’ and ‘output’ are relative.

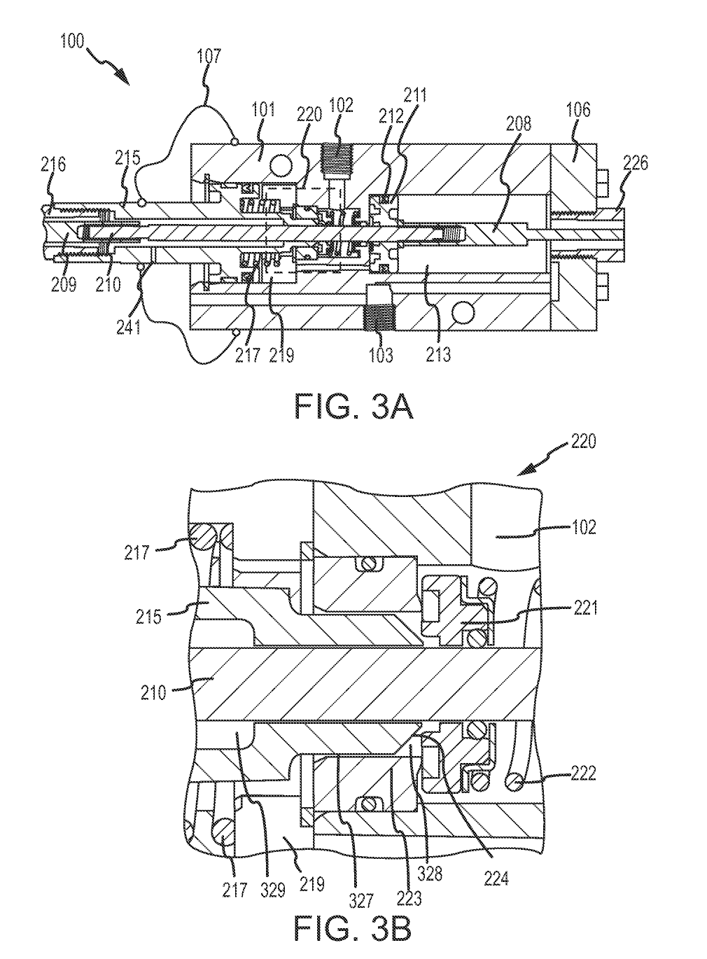

FIG. 3A shows the force amplifier 100 with no force applied to the input force component 208. In this position, the assist piston 211 is positioned fully against the left side of the housing of the assist piston chamber 213. In some embodiments, this is considered to be the “at rest” position.

FIG. 3B shows an exploded view of the poppet chamber 220 according to an embodiment of the invention. In FIG. 3B, there is little or no force applied to the input force component 208. As shown, the regulating poppet 221 is positioned substantially against the regulating supply seat 223. This creates a substantially fluid tight seal and prevents fluid from flowing from the fluid input 102 into the regulating piston chamber 219. However, because the regulating exhaust seat 224 is positioned away from the regulating poppet 221, fluid can flow from the regulating piston chamber 219, through the gap 327 created between the regulating piston 215 and the regulating supply seat 223. Fluid can then travel through the gap 328 created between the regulating exhaust seat 224 and the poppet member 221 and through the exhaust passageway 329 created between the intermediate force component 210 and the regulating piston 215 and eventually to the exhaust hole 241 created in the regulating piston 215. Because the exhaust hole 241 is in communication with the fluid exhaust 103, fluid is free to leave the force amplifier 100. Allowing fluid to leave the force amplifier 100 substantially reduces any pressure buildup that has accumulated within the assist piston chamber 213 and the regulating piston chamber 219.

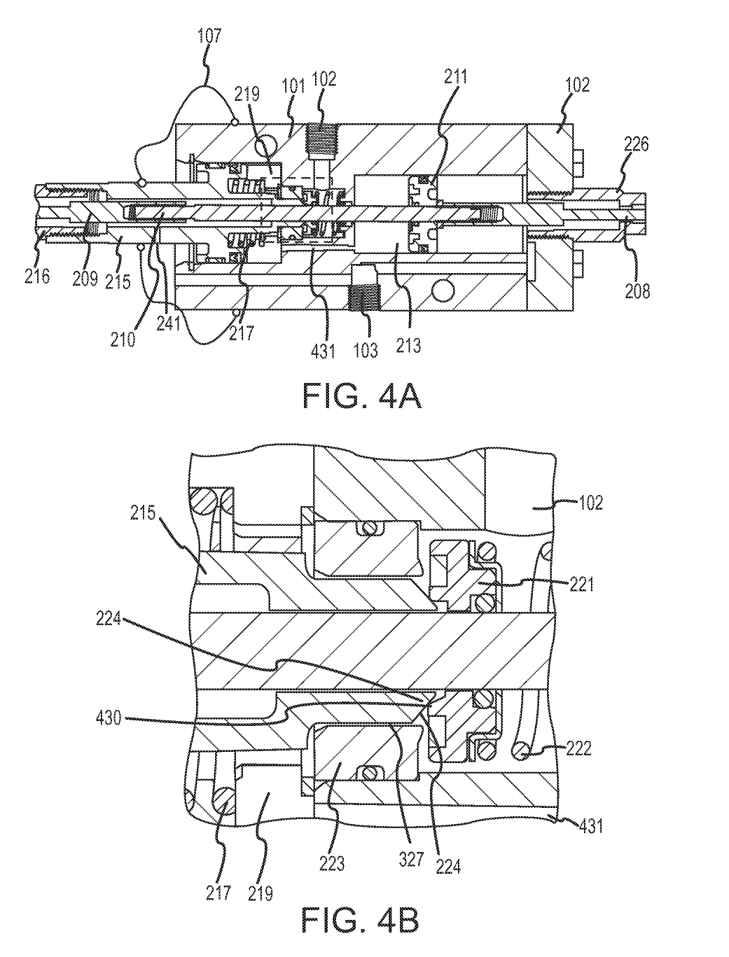

FIGS. 4A and 4B show the force amplifier 100 once a first force has been applied to the force assembly 250. The force provided is shown as a tension on the input force component 208 and pulls the force assembly 250 to the right as shown in FIGS. 4A and 4B. However, the force could be a compressive force on the output force component 209. The input force component 208 is guided by and moves through the input force component conduit 226. The input force component conduit 226 is substantially permanently coupled to the housing 101 and therefore, does not move with the input force component 208. Furthermore, if the input force component conduit 226 is coupled to the Bowden cable system 270, the input force component conduit 226, 226′ can maintain a predetermined spacing between the housing 101 and the firewall 260, for example.

As shown, the assist piston 211 has moved to the right along with the input force component 208. The tension provided on the force assembly 250 causes a compressive force on the regulating piston 215. The first force provided on the force assembly 250, when there is resistance, results in a compressive force acting on the reaction force component conduit 216 using a mechanical conversion device generally known in the art, such as the Bowden cable system 271 or the spring assembly 770. This compressive force is transferred to the regulating piston 215. When the compression provided is high enough, it overcomes the counter force provided by the regulating piston biasing member 217, causing the regulating piston 215 to move slightly to the right as shown in the figures.

As the regulating piston 215 moves to the right, the regulating exhaust seat 224 contacts the regulating poppet 221. Further movement overcomes the force of the regulating poppet biasing member 222 and the regulating piston 215, along with the poppet member 221, moves to the right. As the poppet member 221 is forced to the right, it breaks the seal created with the regulator supply seat 223. As shown in the figures, the regulating piston chamber 219 limits the movement of the regulating piston 215.

Once the seal between the poppet member 221 and the regulator supply seat 223 is broken, fluid is free to enter the gap 430 created between the poppet member 221 and the regulator supply seat 223. If pressurized fluid is provided through the fluid inlet 102, the pressure within the poppet chamber 220 will be greater than the pressure within the regulating piston chamber 219. Therefore, fluid will travel into the gap 430 and through the fluid supply passageway 327 and into the regulating piston chamber 219. Once fluid reaches the regulating piston chamber 219, it can also provide pressure on the assist piston 211 via the assist piston passageway 431. The pressure provided on the assist piston 211 provides a second force.

As pressure within the assist piston chamber 213 increases, the output force of the force assembly 250 comprises the first force and the second force of the pressurized fluid provided on the assist piston 211. The maximum amplification of the force delivered to the output force component 209 can be controlled by the pressure of the fluid being supplied to the force amplifier 100 through the fluid input 102. The amplification force can alternatively or additionally be controlled by the size of the assist piston 211. By changing the cross sectional area of the assist piston 211, the amount of force provided by the pressurized fluid can be controlled for the particular application.

The pressure within the regulating piston chamber 219 provided by the fluid can at least partially counter the compression caused by the reaction force component conduit 216. This takes some of the pressure off from the regulator supply seat 223 caused by contact between the regulating piston 215 and the regulator supply seat 223.

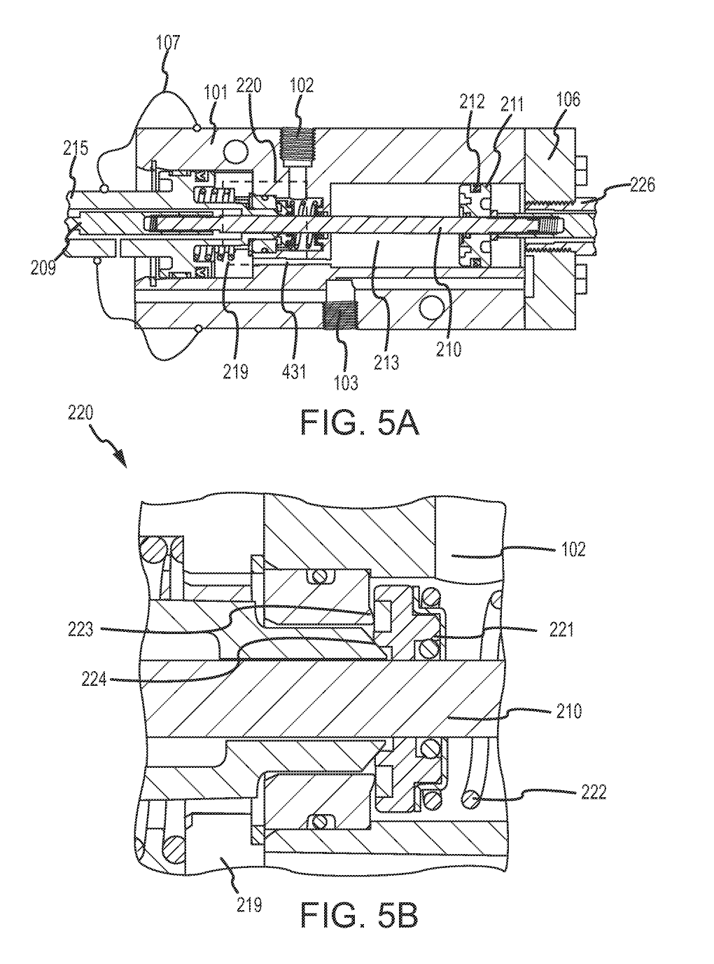

FIGS. 5A and 5B show the force amplifier 100 with the force assembly 250 under a substantially constant input force. With the force on the input force component 208 substantially constant, the pressure within the regulator piston chamber 219 along with the regulating piston biasing member 217 can overcome the compressive force on the regulating piston 215. This moves the regulating piston 215 back to the left slightly, but not completely. Because there is still tension on the output force component 209, there is still a compressive force on the regulating piston 215 due to the Bowden cable sheath 216′ or the spring assembly 770. However, under this equilibrium the regulating piston 215 moves substantially to the position as better seen in FIG. 5B. The equilibrium can be determined based on the area of the regulating piston 215 the pressurized fluid acts along with the pressure of the fluid provided to the regulating piston chamber 219.

FIG. 5B shows the poppet chamber 220 with the force amplifier 100 under a substantially constant tension. As shown, the poppet member 221 is seated against both the regulator supply seat 223 and the regulator exhaust seat 224. Therefore, pressurized fluid is substantially closed off to both the regulating piston chamber 219 and the exhaust 103. In this position, the pressure within the force amplifier 100 is held substantially constant.

When the force provided on the input force component 208 is held substantially constant, the assist piston 211 is still amplifying the force provided on the output force component 209. This can be advantageous, for example, when a user is holding the input force component 208 in a substantially constant position for an extended period of time, for example during clutch actuation.

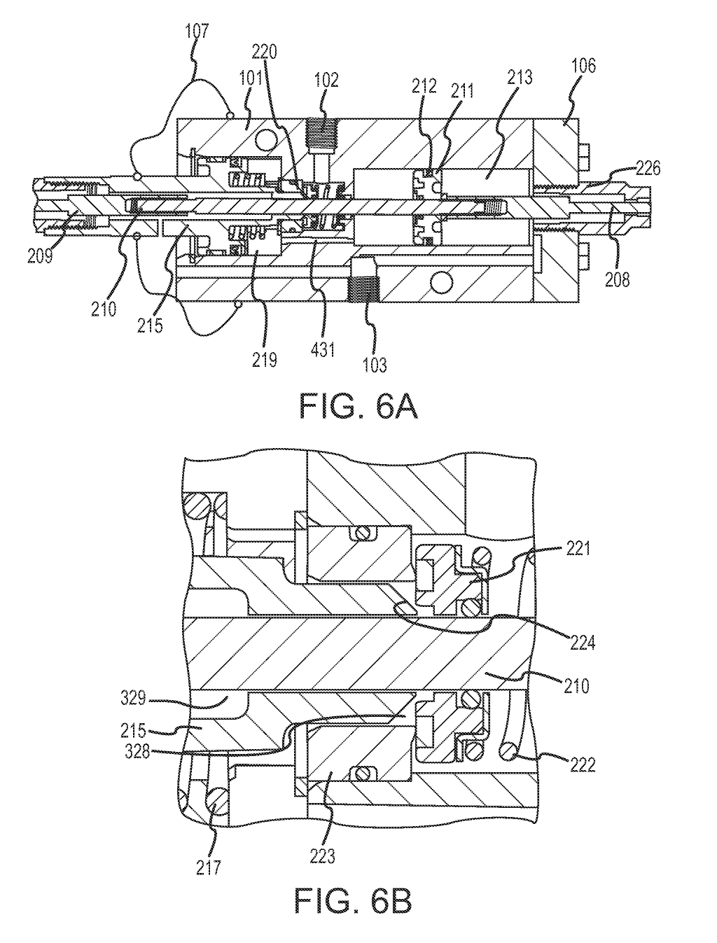

FIGS. 6A and 6B show the force amplifier 100 with the input force on the force assembly 250 decreasing. With the force on the force assembly 250 decreasing, the input force component 208 moves back to the left as shown in the figures. As shown, the regulating piston 215 returns to its original position as well. As the regulating piston 215 returns, the seal between the regulator exhaust seat 224 and the poppet member 221 breaks. This allows the fluid within the assist piston chamber 213 and the regulator piston chamber 217 to exhaust through the gap 328 between the regulator exhaust seat 324 and the poppet member 221. Fluid can then travel through the exhaust passageway 329 created between the intermediate force component 210 and the regulating piston 215. The fluid can then exit the force amplifier 100 through the exhaust hole 241 formed in the regulating piston 215 and out through the fluid exhaust 103.

As described above, the force amplifier 100 provides a number of advantages. With a pressurized fluid provided at the fluid input, the force amplifier 100 can deliver a greater force at the output of the force assembly 250 than provided on the input of the force assembly 250. Furthermore, the assist piston 211 is actuated simply by a force being applied to the input force component 208. Because the regulating piston 215 responds to a force on the force assembly 250, the force provided by the input force component 208 can control the fluid flow to the assist piston 211.

The force amplifier 100 can advantageously operate in the absence of some external power supply. Additionally, in the event of a loss of fluid pressure, a user can still provide an output force. Because the input force component 208 and the output force component 209 can be rigidly coupled to one another, a user's force applied to the input force component 208 still produces a response on the output force component 209. The only difference is that in the absence of fluid supply, the force delivered to the output force component 209 is in a 1:1 ratio with the force provided on the input force component 208. However, because the intermediate force component 210 couples the input force component 208 to the output force component 209 in a rigid manner, i.e., the distance between the input 208 and output 209 components remain substantially constant, the stroke is also in a 1:1 ratio. Therefore, if the fluid pressure is suddenly lost, the stroke of the input force component 208 does not change. Consequently, in the absence of fluid pressure, a user can still safely provide force to the output force component 209.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other force amplifiers, and not just to the embodiments described above and shown in the accompanying figures. Accordingly, the scope of the invention should be determined from the following claims.

We claim:

1. A force amplifier, comprising:
a housing;
a force assembly positioned in the housing and including:
an input force component;
an output force component; and
an intermediate force component rigidly coupling the input force component to the output force component;
an assist piston positioned in the housing, wherein the assist piston is coupled to the force assembly; and
a regulating piston positioned in the housing and coaxially aligned with the assist piston, wherein the regulating piston operates in conjunction with the force assembly and controls a supply of a pressurized fluid acting on the assist piston.

2. The force amplifier of claim 1, further comprising an assist piston passageway providing fluid communication between the assist piston and the regulating piston.

3. The force amplifier of claim 1, further comprising a poppet member, with the poppet member controlling a fluid pressure acting on the regulating piston.

4. The force amplifier of claim 3, wherein the poppet member is biased to a default position by a poppet member biasing devise, the default position substantially closing off a pressurized fluid supply from the regulating piston and the assist piston.

5. The force amplifier of claim 3, wherein a first force acting on the force assembly actuates the regulating piston and the poppet member.

6. The force amplifier of claim 5, wherein the pressurized fluid acting on the assist piston provides a second force.

7. The force amplifier of claim 5, wherein the pressurized fluid acting on the assist piston provides a second force and wherein an output force of the force assembly comprises the first force and the second force.

8. The force amplifier of claim 1, wherein an output force provided on the force assembly comprises a first force when there is no pressure acting on the assist piston.

9. The force amplifier of claim 1, wherein the regulating piston operates in conjunction with the sheath member of a Bowden Cable System.

10. The force amplifier of claim 1, wherein the regulating piston is coupled to the force assembly using a spring assembly.

11. A method for forming a force amplifier including a housing, comprising steps of:
positioning a force assembly in the housing, the force assembly including:
an input force component;
an output force component;
an intermediate force component rigidly coupling the input force component to the output force component;
positioning an assist piston in the housing and coupling the assist piston to the force assembly; and
positioning a regulating piston in the housing coaxially aligned with the assist piston and coupling the regulating piston to the force assembly, wherein the regulating piston controls a supply of a pressurized fluid acting on the assist piston.

12. The method of claim 11, further comprising a step of forming an assist piston passageway providing communication between the assist piston and the regulating piston.

13. The method of claim 11, further comprising a step of positioning a poppet member within a poppet chamber formed in the housing, the poppet member controlling a fluid pressure acting on the regulating piston.

14. The method of claim 12, further comprising a step of biasing a poppet member to a default position using a poppet biasing member, wherein the poppet member substantially closes off a pressurized fluid supply from the regulating piston and the assist piston when in the default position.

15. The method of claim 12, wherein a first force acting on the force assembly actuates the regulating piston and the poppet member.

16. The method of claim 15, wherein the pressurized fluid acting on the assist piston provides a second force.

17. The method of claim 16, wherein an output force of the force assembly comprises the first force and the second force.

18. The method of claim 12, wherein an output force of the force assembly comprises a first force acting on force component when there is no pressure acting on the assist piston.

19. The method of claim 11, wherein the step of coupling the regulating piston to the force assembly comprises using a Bowden cable system.

20. The method of claim 11, wherein the step of coupling the regulating piston to the force assembly comprises using a spring assembly.

21. A method for amplifying a force using a force amplifier, comprising steps of:
receiving a first force on a force assembly;
coupling a regulating piston to the force assembly;
actuating the regulating piston a first force;
providing a pressurized fluid to an assist piston, which is coaxially aligned with the regulating piston, when the regulating piston is actuated; and
generating a second force from the pressurized fluid acting on the assist piston, wherein an output force of the force assembly comprises the first force and the second force.

22. The method of claim 21, wherein the output force comprises the first force when there is a loss of pressure provided on the assist piston.

23. The method of claim 21, further comprising a step of actuating a poppet member with the regulating piston, wherein the poppet member provides a pressurized fluid to the regulating piston and the assist piston when actuated.

24. The method of claim 21, further comprising a step of closing off the pressurized fluid supplied to the regulating piston and to the assist piston and maintaining the pressure acting on the regulating piston and the assist piston when the first force is substantially constant.

25. The method of claim 21, further comprising a step of supplying the pressurized fluid to the regulating piston and to the assist piston when the first force is increasing.

26. The method of claim 21, further comprising steps of closing off the pressurized fluid to the regulating piston and to the assist piston and providing fluid communication between the regulating piston and the fluid exhaust when the first force is decreasing.

27. The method of claim 21, wherein the regulating piston and the force assembly are coupled using a Bowden cable system.

28. The method of claim 21, wherein the regulating piston and the force assembly are coupled using a spring assembly.
